(19) United States
(12) Patent Application Publication
(10) Pub. No.: US 2026/0099891 A1
(43) Pub. Date: Apr. 9, 2026

(54) SEMANTIC CRIME DATA ANALYSIS AND VISUALIZATION FRAMEWORK

(71) Applicants: Subham Kumar, Tempe, AZ (US); Amarjeet Singh, Palkhwah Teh Haroli (IN); Srividya Bansal, Tempe, AZ (US)

(72) Inventors: Subham Kumar, Tempe, AZ (US); Amarjeet Singh, Palkhwah Teh Haroli (IN); Srividya Bansal, Tempe, AZ (US)

(73) Assignee: Arizona Board of Regents on Behalf of Arizona State University, Scottsdale, AZ (US)

(21) Appl. No.: 19/348,599

(22) Filed: Oct. 2, 2025

Related U.S. Application Data
(60) Provisional application No. 63/703,588, filed on Oct. 4, 2024.

(51) Int. Cl. G06Q 50/26; G06F 16/23; G06F 16/245

(52) U.S. Cl. CPC G06Q 50/265; G06F 16/2365; G06F 16/245

(57) ABSTRACT

A computer-implemented method is disclosed for analyzing crime-related data using a structured semantic framework. The method includes interfacing one or more data sources with a crime data analysis framework, defining an ontology that includes classes, properties, and relationships to represent the crime-related data, and pre-processing the data to generate a refined dataset. Pre-processing operations may include removing irrelevant columns, eliminating rows with null fields, and converting temporal values to numerical format. The dataset is transformed and imported into a Resource Description Framework (RDF) datastore accessible to the framework. RDF triples are generated within the datastore to represent relationships among dataset elements. The datastore is exposed to a dashboard user interface module configured to receive queries and return responses. Based on the query responses, the system outputs visualizations of the crime data for display via the dashboard interface.

### CLAIM OF PRIORITY

This application claims the benefit of U.S. Provisional Patent Application No. 63/703,588, filed 4 Oct. 2024, the entire contents of which is incorporated herein by reference.

### TECHNICAL FIELD

Aspects of the invention relate generally to the fields of data management and information processing, including structures and techniques for storing, organizing, and querying data.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

Ontologies and Resource Description Frameworks (RDFs) relate to the organizing, representing, and sharing of information in a systematic and structured manner. An ontology is a formal representation of a set of concepts within a domain and the relationships between those concepts, providing a structured framework for understanding and categorizing data. An RDF is a framework for representing information about resources on the web, for instance by using triples to express data, in which each triple consists of a subject, predicate, and object. This format allows for flexible and extensible data representation.

When used together, ontologies provide the vocabulary and structure for data, while RDF provides the mechanism to encode and interlink that data. This combination enhances the ability to query, analyze, and share data across different systems and organizations.

### SUMMARY

In general, this disclosure is directed to systems, methods, and apparatuses for structuring and analyzing crime-related data using a semantic data framework. As urban environments generate increasing volumes of complex crime-related data, law enforcement agencies and public policy stakeholders face challenges in organizing and analyzing this information in a meaningful way. The techniques described herein enable the transformation of raw crime data into a semantically rich and queryable format. A configurable framework interfaces with various data sources, standardizes the data through pre-processing operations, and maps it to a domain-specific ontology that defines relevant entities, attributes, and relationships. The processed data is then transformed into RDF triples and stored in an RDF datastore, enabling semantic representation and inference. A user interface module provides dashboard access to this datastore, allowing users to issue structured queries and receive real-time responses. Visualizations based on the query results support deeper analysis of crime patterns and trends, enhancing situational awareness, strategic planning, and evidence-based interventions.

In at least one example, processing circuitry is configured to perform a method including: communicably interfacing one or more data sources comprising crime-related data with a framework configured for crime data analysis. According to certain examples, the method includes defining an ontology including classes, properties, and relationships representing the crime-related data. In at least one example, the method includes pre-processing the crime-related data to generate a dataset, the pre-processing comprising at least one of removing analytically irrelevant columns. In another example, the method includes removing rows including fields with null values. In one example, the method includes converting date and time fields to numerical values. According to such examples, the method includes importing the dataset into a Resource Description Framework (RDF) datastore accessible to the framework. In one example, the method includes generating RDF triples within the RDF datastore to represent relationships between elements of the dataset. In at least one example, the method includes exposing the RDF datastore to a dashboard user interface module. According to certain examples, the method includes receiving a query from the dashboard user interface module. In one example, the method includes returning a response to the query from the RDF datastore. In at least one example, the method includes outputting, for display, a data visualization from the dashboard user interface module based on the response.

In one example, the system includes processing circuitry. In another example, the system includes non-transitory computer readable media. In at least one example, the system includes instructions that, when executed by the processing circuitry, configure the processing circuitry to interface one or more data sources comprising crime-related data with a framework configured for crime data analysis. According to certain examples, the system includes instructions that configure the processing circuitry to define an ontology including classes, properties, and relationships representing the crime-related data. In one example, the system includes instructions that configure the processing circuitry to pre-process the crime-related data to generate a dataset, the pre-processing comprising at least one of removing analytically irrelevant columns. In at least one example, the system includes instructions that configure the processing circuitry to remove rows including fields with null values. In another example, the system includes instructions that configure the processing circuitry to convert date and time fields to numerical values. According to certain examples, the system includes instructions that configure the processing circuitry to import the dataset into a Resource Description Framework (RDF) datastore accessible to the framework. In one example, the system includes instructions that configure the processing circuitry to generate RDF triples within the RDF datastore to represent relationships between elements of the dataset. In at least one example, the system includes instructions that configure the processing circuitry to expose the RDF datastore to a dashboard user interface module. According to certain examples, the system includes instructions that configure the processing circuitry to receive a query from the dashboard user interface module. In one example, the system includes instructions that configure the processing circuitry to return a response to the query from the RDF datastore. In at least one example, the system includes instructions that configure the processing circuitry to output, for display, a data visualization from the dashboard user interface module based on the response.

In yet another example, a non-transitory computer-readable storage medium comprises instructions that, when executed, configure processing circuitry to interface one or more data sources comprising crime-related data with a framework configured for crime data analysis. In at least one example, the non-transitory computer-readable storage medium comprises instructions to define an ontology including classes, properties, and relationships representing the crime-related data. According to certain examples, the non-transitory computer-readable storage medium comprises instructions to pre-process the crime-related data to generate a dataset, the pre-processing comprising at least one of removing analytically irrelevant columns. In another example, the non-transitory computer-readable storage medium comprises instructions to remove rows including fields with null values. In at least one example, the non-transitory computer-readable storage medium comprises instructions to convert date and time fields to numerical values. According to certain examples, the non-transitory computer-readable storage medium comprises instructions to import the dataset into a Resource Description Framework (RDF) datastore accessible to the framework. In one example, the non-transitory computer-readable storage medium comprises instructions to generate RDF triples within the RDF datastore to represent relationships between elements of the dataset. In at least one example, the non-transitory computer-readable storage medium comprises instructions to expose the RDF datastore to a dashboard user interface module. According to certain examples, the non-transitory computer-readable storage medium comprises instructions to receive a query from the dashboard user interface module. In one example, the non-transitory computer-readable storage medium comprises instructions to return a response to the query from the RDF datastore. In at least one example, the non-transitory computer-readable storage medium comprises instructions to output, for display, a data visualization from the dashboard user interface module based on the response.

In a particular example, there is a device which includes means for interfacing one or more data sources comprising crime-related data with a framework configured for crime data analysis. The device includes means for defining an ontology including classes, properties, and relationships representing the crime-related data. The device includes means for pre-processing the crime-related data to generate a dataset, the pre-processing comprising at least one of removing analytically irrelevant columns. The device includes means for removing rows including fields with null values. The device includes means for converting date and time fields to numerical values. The device includes means for importing the dataset into a Resource Description Framework (RDF) datastore accessible to the framework. The device includes means for generating RDF triples within the RDF datastore to represent relationships between elements of the dataset. The device includes means for exposing the RDF datastore to a dashboard user interface module. The device includes means for receiving a query from the dashboard user interface module. The device includes means for returning a response to the query from the RDF datastore. The device includes means for outputting, for display, a data visualization from the dashboard user interface module based on the response.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating further details of one example of a computing device, in accordance with aspects of this disclosure.

FIG. 2 provides a high-level design and workflow of a crimewatch framework, in accordance with aspects of this disclosure.

FIG. 3 provides an example ontology design, in accordance with aspects of this disclosure.

FIG. 4 provides an example of query execution within a computing device, in accordance with aspects of this disclosure.

FIG. 5 provides an example of query execution within a computing device, in accordance with aspects of this disclosure.

FIGS. 6A, 6B, and 6C provide examples of dashboard visualizations representing complaints data, in accordance with aspects of the disclosure.

FIGS. 7A, 7B, and 7C provide example dashboard visualizations generated by a crimewatch framework from structured data accessed via a query module, in accordance with aspects of the disclosure.

FIGS. 8A and 8B illustrate hate crime dashboard visualizations generated by a crimewatch framework, in accordance with aspects of the disclosure.

FIG. 9 illustrates a hate crime bar chart in combination with a shooting incident line, in accordance with aspects of the disclosure.

FIG. 10 is a flow diagram illustrating an example method for semantic crime data analysis, in accordance with aspects of this disclosure.

Like reference characters denote like elements throughout the text and figures.

### DETAILED DESCRIPTION

In general, this disclosure is directed to systems, methods, and apparatuses for structuring and analyzing crime-related data using a semantic data framework. As urban environments generate increasing volumes of complex crime-related data, law enforcement agencies and public policy stakeholders face challenges in organizing and analyzing this information in a meaningful way. The techniques described herein enable the transformation of raw crime data into a semantically rich and queryable format. A configurable framework interfaces with various data sources, standardizes the data through pre-processing operations, and maps it to a domain-specific ontology that defines relevant entities, attributes, and relationships. The processed data is then transformed into RDF triples and stored in an RDF datastore, enabling semantic representation and inference. A user interface module provides dashboard access to this datastore, allowing users to issue structured queries and receive real-time responses. Visualizations based on the query results support deeper analysis of crime patterns and trends, enhancing situational awareness, strategic planning, and evidence-based interventions.

The Crimewatch framework and associated analysis tool are designed to address specific challenges arising from the escalation of hate crimes and the complex, interrelated nature of urban violence in environments such as New York City. Leveraging Semantic Web Engineering techniques, the system enables standardized and interoperable representations of crime data using structured ontologies and RDF encoding. Ontologies may define key concepts such as “crime,” “offender,” “victim,” “location,” and “time,” as well as the relationships between them, such as an offender committing a crime at a specific location and time. This semantic modeling allows for consistent interpretation of data across disparate sources. RDF triples are used to represent these structured facts in a machine-readable format, enabling semantic linkage between datasets. For example, RDF triples may encode facts such as “John Doe [subject] committed [predicate] a theft [object]” or “Theft [subject] occurred at [predicate] 123 Elm St [object]”. By supporting complex queries across enriched datasets, the framework facilitates use cases such as demographic analysis, trend detection, hate crime correlation analysis, and the identification of disparities across crime types, enabling more informed decisions and proactive responses.

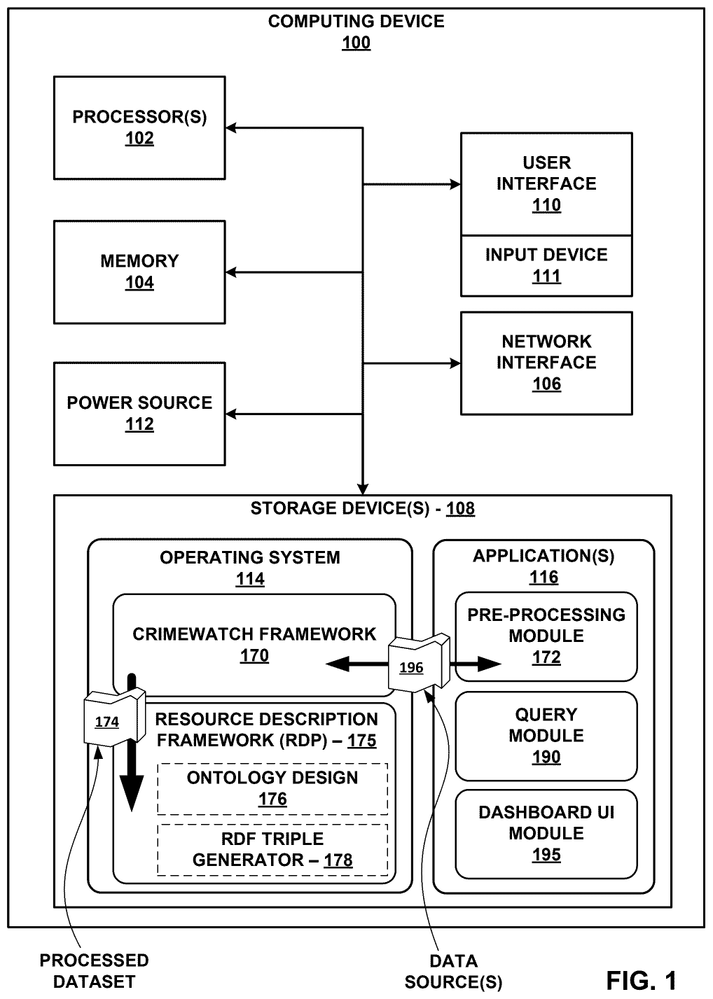

FIG. 1 is a block diagram illustrating further details of one example of computing device 100, in accordance with aspects of this disclosure. FIG. 1 illustrates only one particular example of computing device 100. Many other example embodiments of computing device 100 may be used in other instances.

As shown in the specific example of FIG. 1, computing device 100 may include processor(s) 102, memory 104, network interface 106, storage device(s) 108, user interface 110, input device 111, and power source 112. Computing device 100 may also include operating system 114 and, in some examples, one or more application(s) 116. Application(s) 116 may include pre-processing module 172, query module 190, and dashboard UI module 195.

Operating system 114 may execute functionality of crimewatch framework 170, which receives data from data source(s) 196. Crimewatch framework 170 may interact with resource description framework (RDP) 175 and ontology design 176 to generate RDF triples using RDF triple generator 178. Resource description framework (RDP) 175 may store semantic triples in a linked data format and expose this data to dashboard UI module 195.

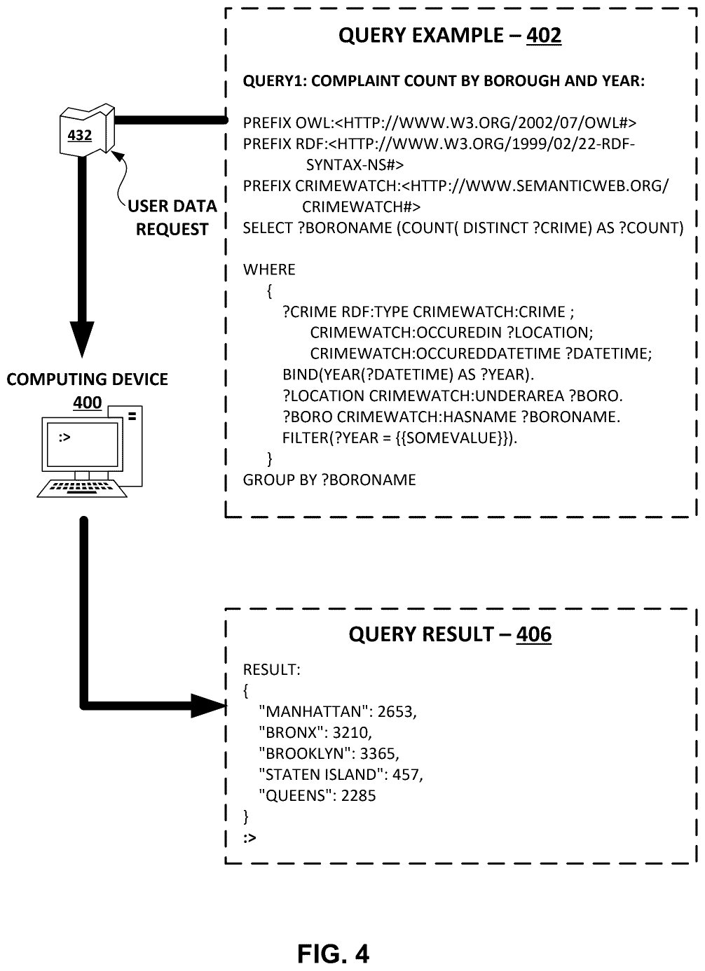

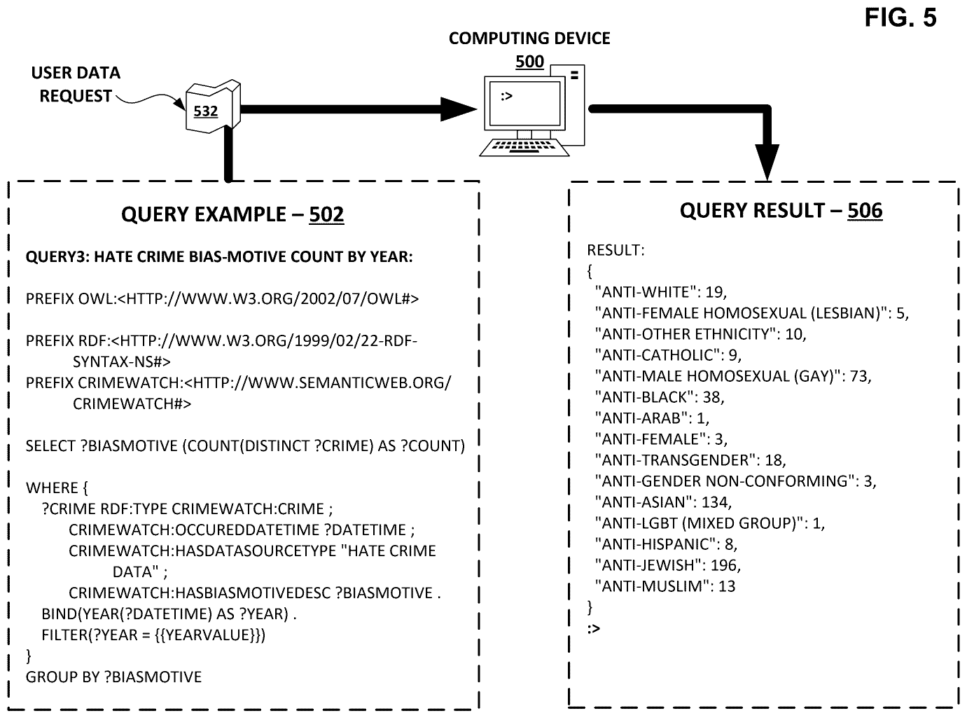

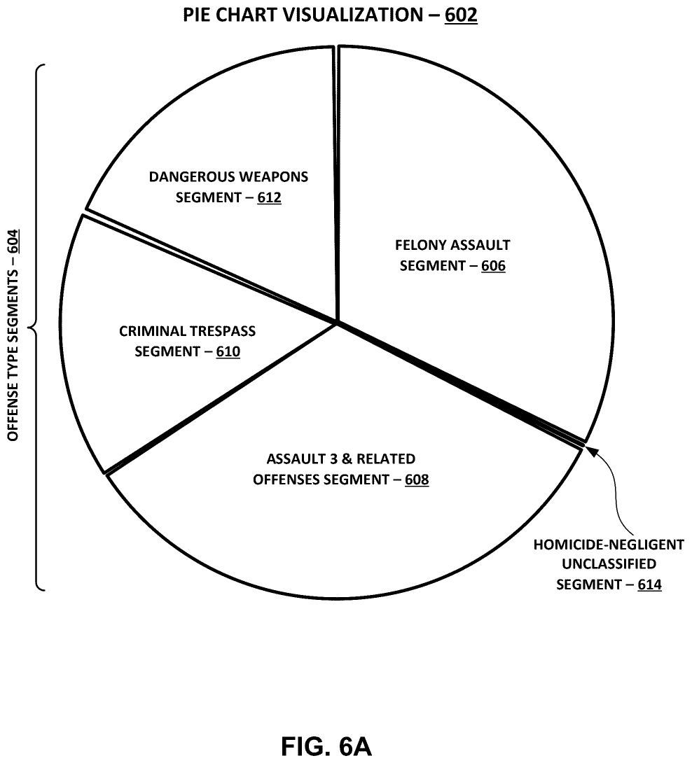

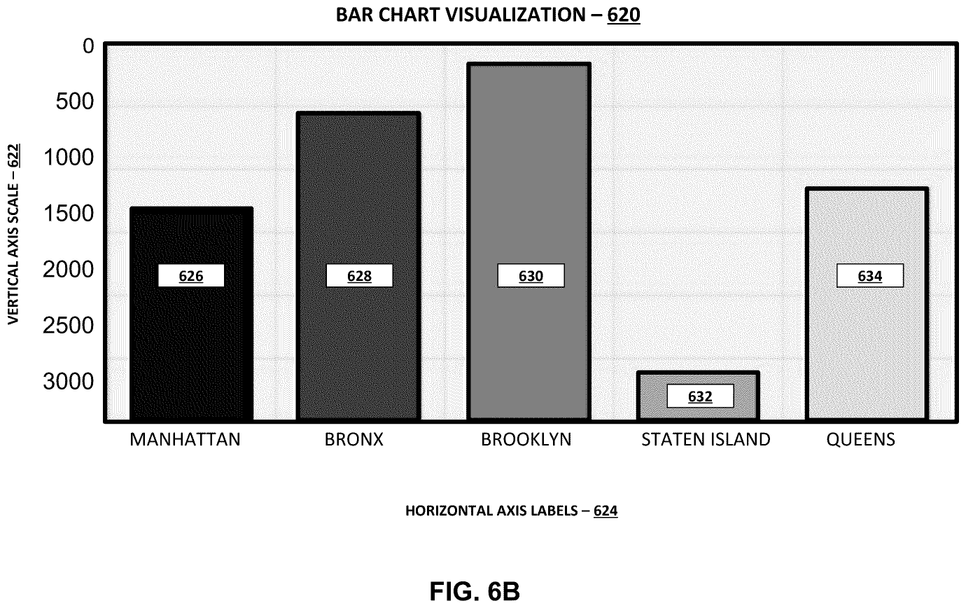

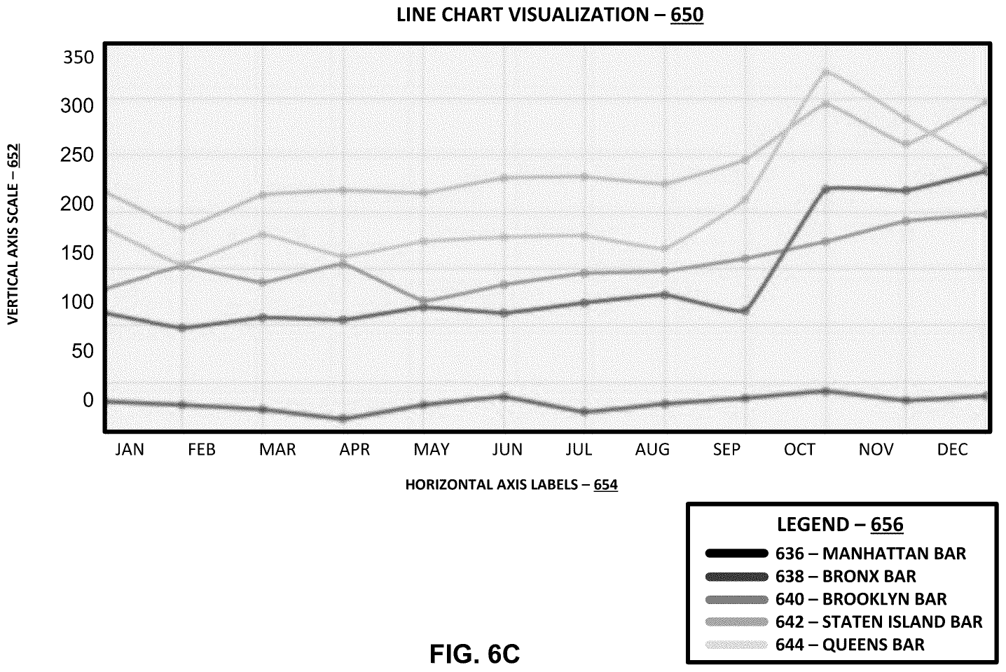

Operating system 114 may enable query module 190 to generate queries from dashboard UI module 195 to crimewatch framework 170, including queries of the type shown in FIGS. 4 and 5. Queries issued by dashboard UI module 195 may be transmitted via query module 190 to resource description framework (RDP) 175, which in turn provides responses for visualization. The architecture enables dashboard UI module 195 to visualize responses to such queries in the form of statistical charts, visualizations, and structured crime analytics, which may be displayed to an end user, as shown in FIG. 6A-6C, 7A-7C, 8A-8B, and 9.

Data received from data source(s) 196 may originate from structured or semi-structured crime records, such as incident reports, complaint filings, or arrest records. Pre-processing module 172 may clean and normalize this data, for example by removing analytically irrelevant columns, eliminating rows containing null values, or converting date and time fields to numerical values. Pre-processing module 172 may output a cleaned and normalized dataset to processed dataset 174. Processed dataset 174 may be stored within computing device 100 and provided as input to resource description framework (RDP) 175 for semantic transformation. Processed dataset 174 feeds into resource description framework (RDP) 175, where RDF triple generator 178 transforms the dataset into RDF triples representing subject-predicate-object relationships that align with ontology design 176.

Ontology design 176 may define core domain concepts relevant to crime data, such as crime, offender, victim, location, and time. Ontology design 176 may also specify relationships among these concepts, such as an offender committing a crime at a specific location and time. Ontology design 176 may be implemented within resource description framework (RDP) 175 and cooperates with RDF triple generator 178 to align dataset relationships with domain-specific classes and properties. RDF triple generator 178 may encode these relationships as RDF triples, for example, “John Doe [subject] committed [predicate] a theft [object]” or “Theft [subject] occurred at [predicate] 123 Elm St [object].”

Once RDF triples are generated and stored within resource description framework (RDP) 175, dashboard UI module 195 may issue semantic queries via query module 190. These queries may be written in a query language such as SPARQL, and may include filters, join operations, or aggregation functions to extract meaningful insights. Responses returned to dashboard UI module 195 may be visualized in the form of graphs, timelines, heat maps, or tabular summaries.

Growing concerns related to public safety and law enforcement in urban environments such as New York City have prompted the need for comprehensive and data-driven approaches to understanding and addressing crime-related issues. While cities thrive on diversity and multiculturalism, hate crimes persist and often manifest in the form of vandalism, harassment, or physical violence. One of the most alarming manifestations of this hatred is when it culminates in shooting incidents. In 2021, hate crime incidents in New York increased by 55%. Crimewatch framework 170 leverages semantic web engineering techniques to organize, enrich, and analyze raw crime data. Ontologies and RDF enable structured representations of this data, helping establish connections between diverse information sources and supporting a deeper understanding of crime patterns.

Converting data from various formats, such as XML, into RDF lays the foundation for comprehensive data analysis. The interconnected nature of mass shootings, hate crimes, and criminal complaints remains a matter of significant concern. This nexus, where violence, bias, and formal documentation of crimes converge, presents a complex and multifaceted problem. Various law enforcement agencies extensively cover these incidents, generating substantial volumes of data including details of crimes, perpetrators, locations, and victims. Yet, the true value of this data in comprehending crime patterns and facilitating proactive measures remains underutilized. Crimewatch framework 170 addresses this gap by applying ontology design 176 to organize crime data into semantically rich graphs that are easier to query and analyze.

Crimewatch framework 170 utilizes a systematic structure that better contextualizes data collected, making it more comprehensible and actionable. Crimewatch framework 170 collects, analyzes, and presents a wide range of crime data, such as shooting incidents, complaints, arrests, and hate crimes occurring in different boroughs of New York. Crimewatch framework 170 may be extended or adapted to other cities and geographic regions by configuring new data source(s) 196. By aggregating, processing, and visualizing data from various data source(s) 196, crimewatch framework 170 provides stakeholders with tools for informed decision making, resource allocation, and proactive crime prevention.

In some examples, processing circuitry including processor(s) 102 implements functionality and/or process instructions for execution within computing device 100. For example, processor(s) 102 may execute instructions stored in memory 104 or instructions retrieved from storage device(s) 108. Memory 104 may store data and instructions during operation. Memory 104 may be a computer-readable storage medium, such as RAM, DRAM, or SRAM, used for temporary storage of program data. In some examples, memory 104 may be used by application(s) 116 to temporarily store information during runtime operations.

Storage device(s) 108 may include long-term computer-readable storage media for larger datasets and persistent storage. Examples include magnetic hard drives, optical discs, flash memory, and EEPROM. Storage device(s) 108 may store crimewatch framework 170, pre-processing module 172, and other application logic.

Network interface 106 may enable computing device 100 to connect to external systems or networks, using Ethernet, Wi-Fi®, 3G/4G/5G, LTE, Bluetooth®, or other protocols. Network interface 106 may also be implemented as a network interface card such as an Ethernet card, an optical transceiver, a radio frequency transceiver, a cellular transceiver or cellular radio, or any other type of device that can send and receive information. In some examples, computing device 100 may use network interface 106 to wirelessly communicate with an external device such as a server, mobile phone, or other networked computing device.

User interface 110 may include input device 111, such as a touch-sensitive display. Input device 111 may be configured to receive input from a user through tactile, electromagnetic, audio, and/or video feedback. Examples of input device 111 may include a touch-sensitive display, mouse, keyboard, voice responsive system, video camera, microphone, or any other type of device for detecting gestures by a user. In some examples, a touch-sensitive display may include a presence-sensitive screen. User interface 110 may also include output devices such as a display screen of a computing device or a touch-sensitive display, including a touch-sensitive display of a mobile computing device. Output devices may be configured to provide output to a user using tactile, audio, or video stimuli. Examples of output devices include displays, sound cards, video graphics adapter cards, or any other type of device for converting a signal into an appropriate form understandable to humans or machines. Additional examples may include a speaker, a cathode ray tube monitor, a liquid crystal display, or other types of devices capable of generating intelligible output to a user.

Power source 112 may be rechargeable and provide power to computing device 100. Examples include batteries made from nickel-cadmium, lithium-ion, or other suitable material. Operating system 114 may be stored in storage device(s) 108 and manages the operation of all components within computing device 100. For example, operating system 114 may facilitate the interaction between application(s) 116 and hardware components of computing device 100.

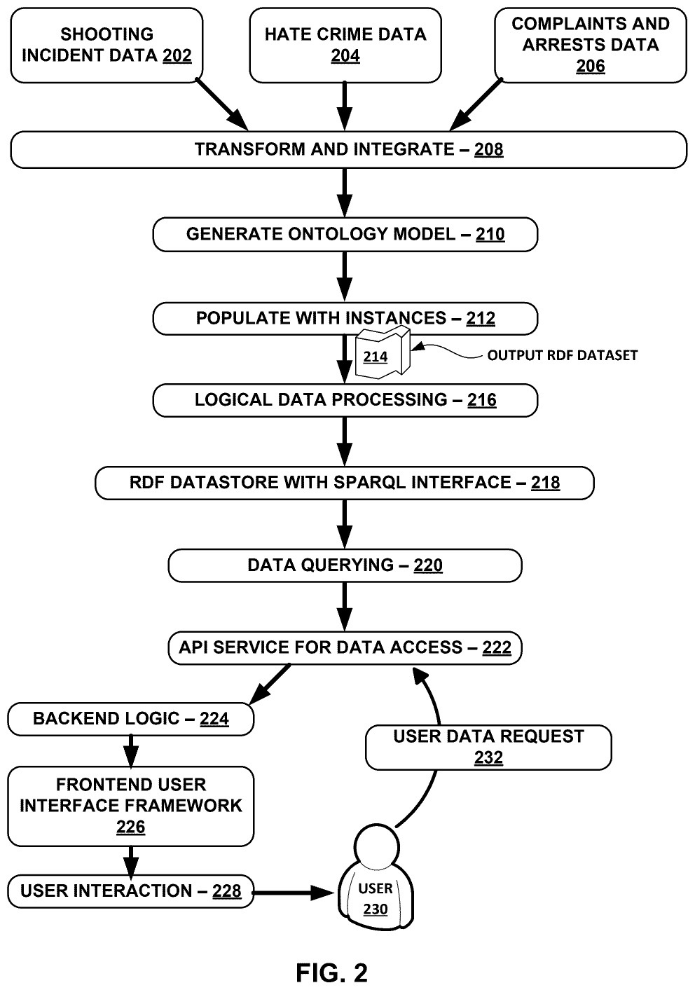

FIG. 2 provides a high-level design and workflow of crimewatch framework 170, in accordance with aspects of this disclosure.

Shooting incident data 202, hate crime data 204, and complaints and arrests data 206 are each transformed and integrated through transform and integrate 208. Transform and integrate 208 may include steps such as removing analytically irrelevant fields, normalizing date and time values, resolving inconsistent identifiers, and mapping fields to align with an ontology model. In some examples, transform and integrate 208 may also include conversion of raw data formats such as XML or JSON into structured tabular data such as CSV prior to semantic transformation.

Transform and integrate 208 outputs into ontology model 210. Ontology model 210 may be implemented in an ontology editing environment configured to define concepts, classes, and relationships for crime-related data. Ontology model 210 specifies subject-predicate-object structures to represent key aspects of crimes, including offenders, victims, locations, times, and other attributes. Ontology model 210 may be populated with instances through populate with instances 212. Populate with instances 212 applies transformation rules to the data, ensuring consistency with ontology model 210. RDF dataset 214 represents the linked data output that encodes crime-related information as triples, which are subsequently processed and stored.

Populate with instances 212 produces RDF dataset 214, which encodes the crime-related data as linked triples compatible with semantic web standards. RDF dataset 214 outputs to logical data processing 216, where additional semantic rules, constraints, and validation checks may be applied. Logical data processing 216 may also include alignment across multiple datasets, integration of temporal relationships, and enrichment using auxiliary sources.

Logical data processing 216 outputs to RDF datastore with SPARQL interface 218. RDF datastore with SPARQL interface 218 provides storage and indexing of RDF triples while exposing a query interface compatible with SPARQL. Data querying 220 receives queries formulated in a SPARQL-compatible syntax and produces structured responses. Data querying 220 outputs to API service for data access 222.

API service for data access 222 provides endpoints that expose the results of data querying 220 to external modules. Backend logic 224 may receive responses from API service for data access 222 and apply additional business rules, aggregations, or formatting operations. Backend logic 224 outputs to frontend user interface framework 226, which renders visualizations such as charts, graphs, or dashboards and communicates with user interaction 228.

User 230 interacts with frontend user interface framework 226 through user interaction 228. User 230 may also issue user data request 232, which is received by API service for data access 222 and routed to data querying 220 for fulfillment. The resulting response is processed by backend logic 224 and displayed by frontend user interface framework 226, thereby completing the interaction loop.

In some examples, ontology model 210 may be generated using ontology editing tools such as Protégé, and RDF datastore with SPARQL interface 218 may be implemented using a triple store supporting semantic web standards, although other equivalent tools may be substituted. API service for data access 222 may be configured as a RESTful service implemented in a web framework such as Java Spring. Frontend user interface framework 226 may be implemented using a web application framework such as Vue.js. Such implementations are non-limiting examples, and other tools and technologies may be applied to achieve the described functionality.

The workflow shown in FIG. 2 supports use cases of crimewatch framework 170 including temporal analysis of crime incidents, gender-specific trends, demographic disparities, hate crime insights, and correlation of shootings with hate crimes. For example, ontology model 210 and RDF dataset 214 enable representation of temporal fields such that data querying 220 can compute incident counts per month or year. Backend logic 224 may aggregate incident types by gender, and frontend user interface framework 226 may visualize the top five crimes reported annually by gender. RDF datastore with SPARQL interface 218 may maintain demographic attributes that allow queries for shooting incidents by race, age, or borough, enabling dashboards to reveal disparities in perpetrator and victim data.

Similarly, user data request 232 may trigger queries that return borough-level hate crime frequencies or breakdowns by motive. Comparative queries may also be processed by data querying 220 to generate trend analyses that relate shooting incidents to hate crime incidents, with results rendered via frontend user interface framework 226 to provide stakeholders with correlation insights.

The dataset for crimewatch framework 170 used in the examples described herein was extracted from the New York City open data website. The NYC data source 196 provides different types of datasets related to different incidents happening in the city, offering valuable datasets for analysis and research purposes.

Experimentation with crimewatch framework 170 focused on three different NYPD datasets related to shootings, events, and hate crimes as they align closely with the capabilities of crimewatch framework 170. The first dataset, NYPD shooting incident data, provides all the information about the shooting incidents with 21 columns and 27.3K rows, each row in this dataset representing a unique shooting incident.

There are various variables such as the occurrence date and time, borough along with latitude and longitude values for geographical context, and other details containing information about the perpetrator and victim. Each of the columns was consumed as analytically significant to crimewatch framework 170.

The hate crime dataset provides crimewatch framework 170 detailed information related to the different hate crimes that occurred in New York City. In this raw dataset, there are a total of 2.2 k rows and 14 columns. The different columns provide essential conceptual information about each distinct hate crime incident. The dataset contains columns such as complaint ID, and demographic details such as borough name and county name, offense type, and occurrence date and time, which play an important role in crimewatch framework 170 use cases. Some columns such as arrest date, arrest ID, and duplicate columns such as month number and complaint year do not completely align with crimewatch framework 170 capabilities and were not analytically significant.

Analysis by crimewatch framework 170 is further enriched by the inclusion of the NYPD complaint data, which offers a comprehensive view of various types of incidents reported in New York City. This dataset includes 35 columns and approximately 8.35 million rows, with each row corresponding to a distinct complaint. The dataset's focus aligns with attributes such as date and time of occurrence, borough of occurrence for geographical context, level of offense for gauging incident severity, and detailed information regarding suspect details and victim details. Additionally, the arrest date assumes paramount importance in understanding the resolution of complaints. The analysis of this dataset yields insights into the wide spectrum of complaints and incidents within the city.

To fulfill crimewatch framework 170 use cases, data pre-processing was performed as all three datasets had missing and inconsistent values. Some columns were either duplicates or were not analytically significant to crimewatch framework 170 use cases and were therefore dropped during data pre-processing. Rows with missing column values were dropped to maintain data consistency. Categorical values such as age groups were handled by assigning integer values to each group for ease of querying the data and linking it with other datasets. Python scripts were used for data pre-processing to avoid manual error and to reduce the time required.

In some implementations, the pre-processing operations may be automated using scripting languages and libraries to improve reproducibility and reduce manual errors. For example, Python scripts may be used to implement data cleaning steps. Libraries such as Pandas and NumPy can be employed to handle structured tabular data, manage missing values, and perform efficient numerical transformations. These scripts may encode categorical values, such as age groups or borough identifiers, into integer representations suitable for querying and linking with other datasets. Automating preprocessing in this way reduces the time required to prepare raw datasets and ensures consistent handling of large data collections.

The scripts used various Python libraries such as Pandas and NumPy to complete this task. NumPy (Numerical Python) provides support for large, multi-dimensional arrays and matrices, along with a collection of mathematical functions to operate on these arrays. Pandas builds on NumPy, providing data structures and functions designed to work with structured data seamlessly, such as tables and time series.

To streamline data storage and retrieval, crimewatch framework 170 utilizes Apache Fuseki as the hosting platform for RDF data, functioning as a robust triple store. Distinct datasets are tailored to accommodate various data types, aligning with specific requirements. This configuration ensures the structured storage and effective management of semantic data. By loading RDF data onto the Fuseki server, users can conduct queries efficiently, enabling the extraction of valuable insights from the stored information.

Crimewatch framework 170 implements and exposes APIs, such as Spring Boot APIs, that communicate with the Fuseki triple store. This API serves as query module 190 (see FIG. 1), facilitating SPARQL queries for data retrieval. Crimewatch framework 170 ensures the API provides organized endpoints and detailed documentation, ensuring user friendliness and accessibility. Users may be guided through the query process by dashboard UI module 195 which interfaces to query module 190, enabling users to retrieve data aligned with predefined use cases.

Crimewatch framework 170 also provides a frontend web application via dashboard UI module 195 using web technologies and JavaScript frameworks. To enhance the user experience, crimewatch framework 170 integrates data visualization libraries such as Chart.js to provide interactive and visually engaging charts and graphs. Application of crimewatch framework 170 enables a user-friendly interface, enabling effortless interaction with the data. Crimewatch framework 170 includes functionalities for user interaction, allowing exploration of predefined use cases. Using dashboard UI module 195, stakeholders can access visual representations such as charts, graphs, and maps, presenting analytical results that offer valuable insights for informed decision-making.

The dashboard interface may be implemented using modern web application frameworks that support modular design and responsive rendering. In some examples, the frontend user interface may be developed using Vue.js, which provides component-based architecture and efficient state management for interactive applications. Data visualizations within the dashboard may be generated using Chart.js, which supports multiple chart types such as line, bar, pie, and scatter plots. By combining Vue.js with Chart.js, the framework provides stakeholders with accessible, real-time graphical representations of analysis results through an interface that can be deployed across desktop and mobile platforms.

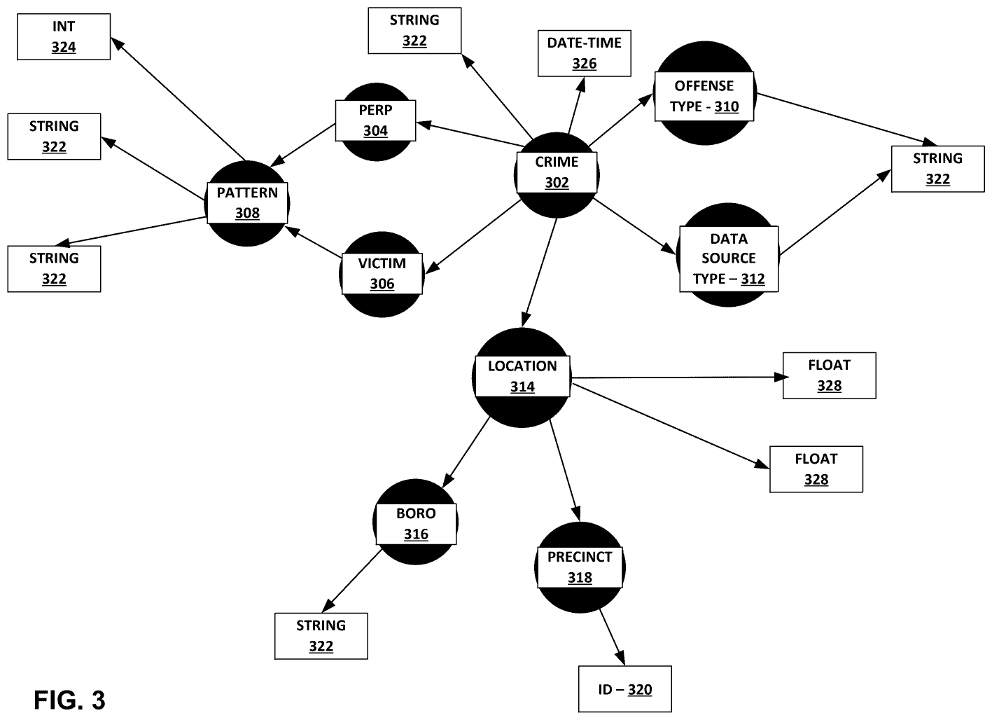

FIG. 3 provides an example ontology design, in accordance with aspects of this disclosure.

Crime 302 represents a core class of the ontology and serves as the central node of the model. Crime 302 receives input from perp 304 and victim 306. Crime 302 also outputs to offense type 310, data source type 312, and location 314. Offense type 310 outputs to string 322, which specifies the type of offense as a textual attribute. Data source type 312 outputs to string 322, which identifies the originating data source of the record. Crime 302 further receives input from date-time 326, which specifies the temporal occurrence of the incident.

Pattern 308 is linked to crime 302 and receives input from perp 304 and victim 306. Pattern 308 also outputs to string 322 and int 324, which represent descriptive text and numerical identifiers characterizing the pattern. Pattern 308 may capture recurring trends, such as repeated offenses by the same perpetrator or repeated incidents within a similar geographic area.

Location 314 receives input from crime 302 and outputs to boro 316 and precinct 318. Boro 316 outputs to string 322, which specifies the borough in which an incident occurred. Precinct 318 outputs to id 320, which identifies the unique precinct code associated with the incident. Location 314 further outputs to float 328, which may represent latitude and longitude values or other numerical coordinates to capture the spatial occurrence of crime incidents.

Perp 304 may include attributes linked to string 322, representing identifiers or demographic details about the perpetrator. Victim 306 may likewise include string 322 attributes that represent victim identifiers or demographic descriptors.

The ontology design illustrated in FIG. 3 provides a structured representation of crime-related data, specifying classes, relationships, and datatypes to capture critical information such as participants, events, locations, times, and contextual attributes. RDF triples may be generated from these relationships, for example, “crime 302 occurred at location 314 with coordinates float 328,” or “perp 304 committed crime 302 of offense type 310.” These triples align with ontology design 176 of FIG. 1 to create machine-readable, semantically enriched datasets that can be queried and visualized through the architecture of FIG. 2.

Ontology design 176 instantiated as shown in FIG. 3 enables semantic interoperability across heterogeneous crime datasets. For example, string 322 attributes standardize disparate textual labels, while float 328 attributes normalize numeric spatial data. Date-time 326 enables temporal analyses, and pattern 308 enables discovery of correlations across incidents. This ontology structure thereby supports queries for crime counts over time, distributions of crimes across locations, demographic breakdowns of perpetrators and victims, and the relationship of specific patterns to hate crimes or shootings.

Ontology design 176 of FIG. 1 and ontology model 210 of FIG. 2 may be instantiated according to the relationships shown in FIG. 3. In this example, crime 302, perp 304, victim 306, pattern 308, offense type 310, data source type 312, location 314, boro 316, and precinct 318 define classes and properties that capture structural relationships in the data. Datatype nodes including string 322, int 324, date-time 326, float 328, and id 320 specify the permitted data formats for attributes of these classes. This instantiation demonstrates how the abstract framework of FIG. 1 and the workflow of FIG. 2 are concretely represented in a semantic model that supports RDF triple generation and query execution.

With reference again to FIG. 3, the ontology serves as a structured framework for capturing essential details about crime incidents and their contextual information to meet use cases of crimewatch framework 170. It includes major classes such as perpetrator and victim information, crime location, crime type, and the data source. Each crime incident is uniquely identified by a crime ID and includes the occurrence date and time. To provide a detailed representation of crime locations, the location class is further categorized into two subclasses: boro and precinct.

Object properties, such as “has victim” and “has perpetrator,” establish connections between the crime class and the victim and perpetrator classes, facilitating the association of individuals with specific incidents. The various object properties are defined to link different classes, enabling a comprehensive understanding of crime incidents.

Data properties, including age, sex, race, and precinct ID, are defined to relate instances to specific data values. This comprehensive ontology design underpins the data organization and semantic enrichment by crimewatch framework 170, enhancing the analysis of crime-related information. The ontology's structure and relationships can be visualized in FIG. 3.

The ontology for crime-related data may be constructed using a structured methodology to ensure consistency and completeness. One example process, sometimes referred to as the ENTERPRISE approach, includes multiple stages of ontology development. These stages may involve eliciting requirements from stakeholders to determine what concepts and relationships should be represented, naming and conceptualizing the core concepts within the domain, managing terminology to ensure consistent definitions, and formally expressing relationships using representation languages such as RDF and OWL. Additional stages may include review and validation to confirm alignment with requirements, publication and deployment of the ontology for broader use, integration with other systems, ongoing improvement and maintenance, and documentation and training to support use by others. Applying such a structured methodology enables the ontology to serve as a robust foundation for semantic enrichment and querying of crime-related data.

The implementation of crimewatch framework 170 includes a well-organized process that involves a series of steps which are discussed below.

Ontology design for crimewatch framework 170 may be implemented using one or more ontology editing tools, such as Protégé, WebProtégé, TopBraid Composer, or other comparable environments capable of defining semantic classes, properties, and relationships. Regardless of the specific tool, ontology design provides a structured framework that enables data organization and semantic enrichment. Crimewatch framework 170 may therefore be configured to align ontology development with specific requirements and use cases.

Following ontology creation, crimewatch framework 170 performs data cleaning and preparation. The raw datasets obtained from data sources 196 (such as the New York City Open Data website) are processed using Python scripts to ensure data quality. Irrelevant columns are removed, and various strategies are applied to handle missing or inconsistent data. This data pre-processing step makes the datasets suitable for RDF conversion.

The cleaned and refined excel data is converted into RDF file format using a Cellifi plugin in Protégé. This step transforms the excel/csv data into a linked data format that adheres with the ontology design. Different transformation rules are applied on top of this tabular data to generate the axioms and the relations between these. RDF triples are generated which establish relationships between different entities, connecting various aspects of crime incidents, including victims, perpetrators, locations, and temporal information.

FIG. 4 provides an example of query execution within computing device 400, in accordance with aspects of this disclosure. In this example, user data request 432 initiates a request for crime statistics and feeds into computing device 400, which in turn executes query example 402. Query example 402 illustrates a SPARQL query directed toward a complaints count by borough for a selected year. Query example 402 specifies a namespace prefix for Resource Description Framework (RDF), Web Ontology Language (OWL), and a crimewatch namespace. User data request 432 denotes an input request initiated by a user, which triggers execution of the illustrated query. The query selects borough names and counts distinct crime 302 instances by grouping them according to borough entities defined in ontology design 176 of FIG. 1 and ontology model 210 of FIG. 2. The query references location 314 and boro 316 from FIG. 3, binding the year field from a date-time 326 attribute and applying a filter that restricts the dataset to a given year.

Computing device 400 executes query example 402 by transmitting the query to query module 190 and data querying 220 of FIG. 2, which in turn interfaces with RDF datastore with SPARQL interface 218. Query module 190 interprets the query using the RDF triples generated by RDF triple generator 178 and stored in resource description framework 175 of FIG. 1. Results from the datastore are then passed back through API service for data access 222 to be formatted for display.

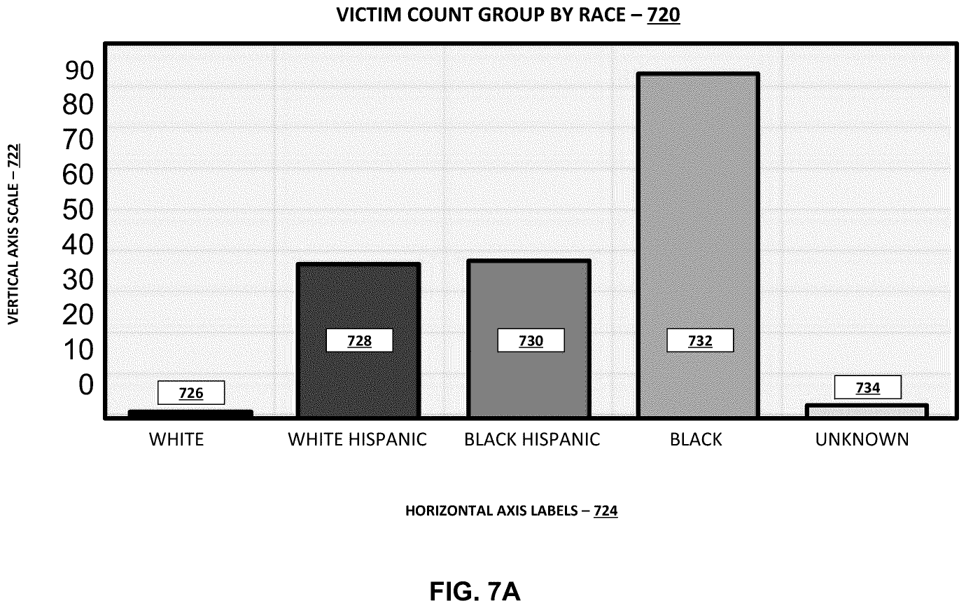

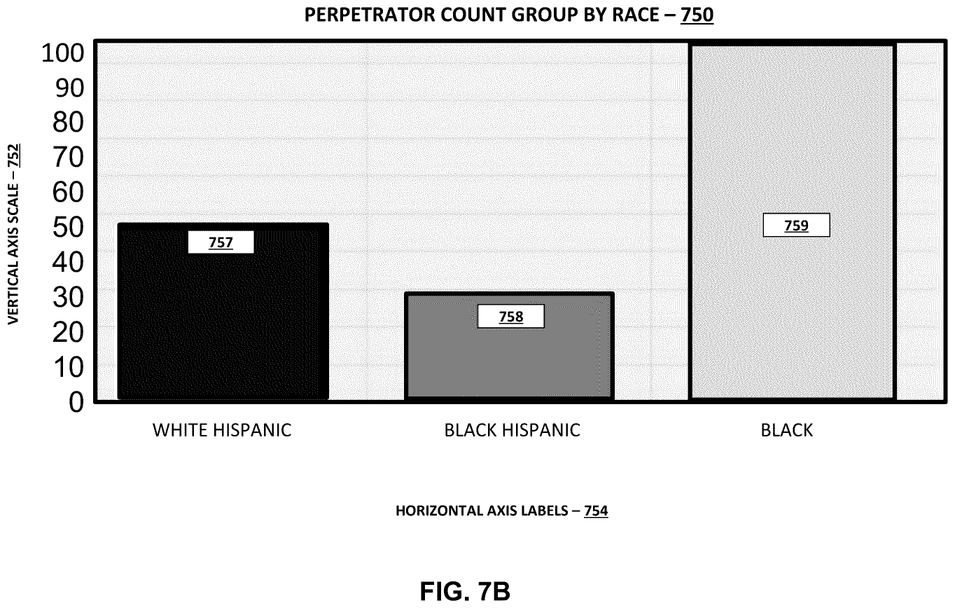

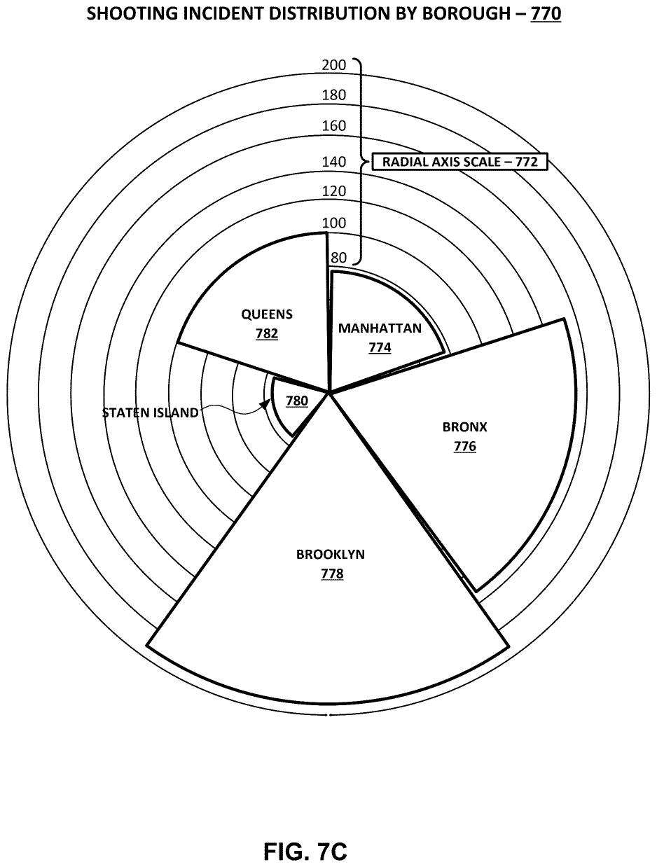

Query result 406 shows an example output dataset generated in response to query example 402. In this instance, complaint counts for boroughs Manhattan, Bronx, Brooklyn, Staten Island, and Queens are returned as numerical values. These values correspond to instances defined in ontology design 176 where class boro 316 contains identifiers bound to string 322 names representing each borough. Query result 406 may be further processed by backend logic 224 and visualized by frontend user interface framework 226 to produce charts or tables, such as those shown in FIG. 6A-6C and 7A-7C.

This example demonstrates how user data request 232 of FIG. 2 may be fulfilled by preparing a semantic query that leverages structured relationships defined in FIG. 3. The linkage across figures shows how ontology design 176 enables queries to reference crime-related classes, locations, and temporal fields, and how the RDF datastore returns values that support visualization in dashboard UI module 195.

FIG. 5 provides an example of query execution within computing device 500, in accordance with aspects of this disclosure. In this example, user data request 532 initiates a request for hate crime statistics and feeds into computing device 500, which in turn executes query example 502. Query example 502 illustrates a SPARQL query directed toward a bias motive count for a selected year. Query example 502 specifies a namespace prefix for Resource Description Framework (RDF), Web Ontology Language (OWL), and a crimewatch namespace. User data request 532 denotes an input request for hate crime statistics, which initiates execution of the corresponding query. The query selects bias motive values and counts distinct crime 302 instances by grouping them according to bias motive entities defined in ontology design 176 of FIG. 1 and ontology model 210 of FIG. 2. The query references attributes from FIG. 3, including date-time 326 and data source type 312, binding the year field and applying a filter that restricts the dataset to a given year.

The OWL ontology model is populated with real-world instances into an RDF file. To facilitate user queries via query module 190 (see FIG. 1), Jena and Fuseki tools may be utilized as a standalone server, leveraging SPARQL for precise data filtering. Jena and Fuseki are tools related to working with RDF data and SPARQL queries, commonly used in semantic web technologies and ontology management. Apache Jena is an open-source Java framework for building semantic web and linked data applications, providing a suite of tools and libraries for working with RDF data and OWL ontologies. Jena enables developers to manage RDF data and ontologies within Java applications. Apache Jena Fuseki is a component of the Jena project, providing a SPARQL server for querying and updating RDF data. Fuseki hosts RDF data, supports SPARQL, and provides an HTTP interface, thereby exposing RDF data for programmatic query execution. Jena enables Java applications to programmatically work with RDF and ontologies, while Fuseki serves as the backend that delivers SPARQL querying capabilities for external requests such as user data request 532.

The functionality of Jena and Fuseki is exposed through RESTful APIs developed with Java Springboot. These APIs serve as the communicative layer between backend logic 224 (see FIG. 2) and dashboard UI module 195 (see FIG. 1). Computing device 500 receives query example 502 via API service for data access 222, executes the query against RDF datastore with SPARQL interface 218, and returns query result 506. The dashboard interface, which may be implemented using Vue.js, provides an accessible platform for users to engage with query results such as query result 506. Vue.js is an open-source JavaScript framework for building user interfaces and single-page applications, and in this framework it supports visualization and user interaction.

By integrating RESTful APIs, crimewatch framework 170 enables scalable and flexible interactions between the frontend and backend, ensuring efficiency while supporting thorough exploration of NYC crime data. Ontologies play a central role in this process. Crimewatch framework 170 provides detailed methods for ontology creation and customization. For example, the ENTERPRISE process for ontology development is a structured methodology that includes elicitation of requirements, naming and conceptualization of concepts, terminology management, expression and representation using RDF and OWL, review and validation, publication and deployment, reuse and integration, improvement and maintenance, support and documentation, and education and training. This process ensures ontologies are systematically developed to meet application needs.

The ENTERPRISE approach also highlights four main stages for ontology development: identifying purpose, building the ontology, evaluation, and documentation. During ontology development, essential domain concepts are identified, relationships are defined, terminology is selected, and ontologies are encoded in RDF and OWL. Specialized ontologies can be created for criminal investigations, categorizing and structuring crime knowledge domains.

In one implementation, crimewatch framework 170 may conform to the PREVISION ontology, developed under the European Union's PREVISION project. The PREVISION ontology applies semantic technologies to emergency and crisis management, supporting communication, information sharing, and decision-making. PREVISION emphasizes the intelligent pentagram framework and covers concepts including events, places, persons, and equipment. These structures can be adapted to crime analysis applications by linking recorded incidents, attributes, and related entities. Visualization of such ontology structures is a key capability for enabling effective management of large and complex datasets.

Thus, query example 502 and query result 506 illustrate how semantic modeling, RDF data structuring, and ontology-driven queries enable detailed analyses of bias-motivated crimes, supporting accurate, contextualized, and actionable insight.

SPARQL queries may be utilized within crimewatch framework 170 to analyze diverse scenarios encompassing complaints, shooting incidents, and hate crimes. These queries are designed to calculate several metrics, such as the yearly count of various complaint types, monthly trends in complaints per year, the enumeration of shooting incidents categorized by boroughs, counts of victim and perpetrator incidents based on race within specified boroughs, annual tallies of bias motives, and the compilation of hate crime occurrences per borough on an annual basis.

FIGS. 4 and 5 illustrate sample queries used. Other queries may be pre-formed and configured into crimewatch framework 170 to provide the resulting dashboard UI module 195 screenshots depicted via FIG. 6A-6C, 7A-7C, 8A-8B, and 9.

FIGS. 6A, 6B, and 6C provide examples of dashboard visualizations representing complaints data, in accordance with aspects of the disclosure.

FIG. 6A illustrates pie chart visualization 602, which includes offense type segments 604. Offense type segments 604 are divided into felony assault segment 606, assault 3 and related offenses segment 608, criminal trespass segment 610, dangerous weapons segment 612, and homicide-negligent unclassified segment 614. Segment 608 represents Assault 3 and related offenses, forming one categorical portion of the pie chart visualization. Each of these segments represents a categorical portion of complaint instances based on offense type, enabling users to quickly identify distribution across different crime classifications.

FIG. 6B illustrates bar chart visualization 620, which plots borough complaint counts along vertical axis scale 622 and horizontal axis labels 624. Horizontal axis labels 624 correspond to borough categories, including Manhattan bar 626, Bronx bar 628, Brooklyn bar 630, Staten Island bar 632, and Queens bar 634. Each bar represents the aggregated number of complaints for the respective borough.

FIG. 6C illustrates line chart visualization 650, which depicts complaint counts by borough distributed over time. Line chart visualization 650 includes vertical axis scale 652 and horizontal axis labels 654. Borough-specific bars include Manhattan bar 636, Bronx bar 638, Brooklyn bar 640, Staten Island bar 642, and Queens bar 644. Each bar represents aggregated complaint counts for the respective borough across the temporal scale. The monthly timeline across horizontal axis labels 654 provides a temporal view of data trends. Legend 656 maps each plotted line to borough identifiers: Manhattan bar 636, Bronx bar 638, Brooklyn bar 640, Staten Island bar 642, and Queens bar 644. Each line indicates changes in complaint volume for the corresponding borough over the months of a selected year, supporting temporal and comparative analysis.

FIGS. 7A, 7B, and 7C provide example dashboard visualizations generated by crimewatch framework 170 from structured data accessed via query module 190, in accordance with aspects of the disclosure.

Each visualization receives input from data querying 220 and outputs to dashboard UI module 195 for display within a user interface. The examples illustrate how aggregated shooting-related metrics are presented across race and borough dimensions.

FIG. 7A illustrates victim count group by race 720. Victim count group by race 720 includes vertical axis scale 722, horizontal axis labels 724, White 726, White Hispanic 728, Black Hispanic 730, Black 732, and unknown 734.

FIG. 7B illustrates perpetrator count group by race 750. Perpetrator count group by race 750 includes vertical axis scale 752, horizontal axis labels 754, White Hispanic 757, Black Hispanic 758, and Black 759.

FIG. 7C illustrates shooting incident distribution by borough 770. Radial axis scale 772 provides magnitude reference values. Labels 774, 776, 778, 780, and 782 respectively correspond to Manhattan, Bronx, Brooklyn, Staten Island, and Queens. These elements enable comparative visualization of borough-level distribution within a radial chart format.

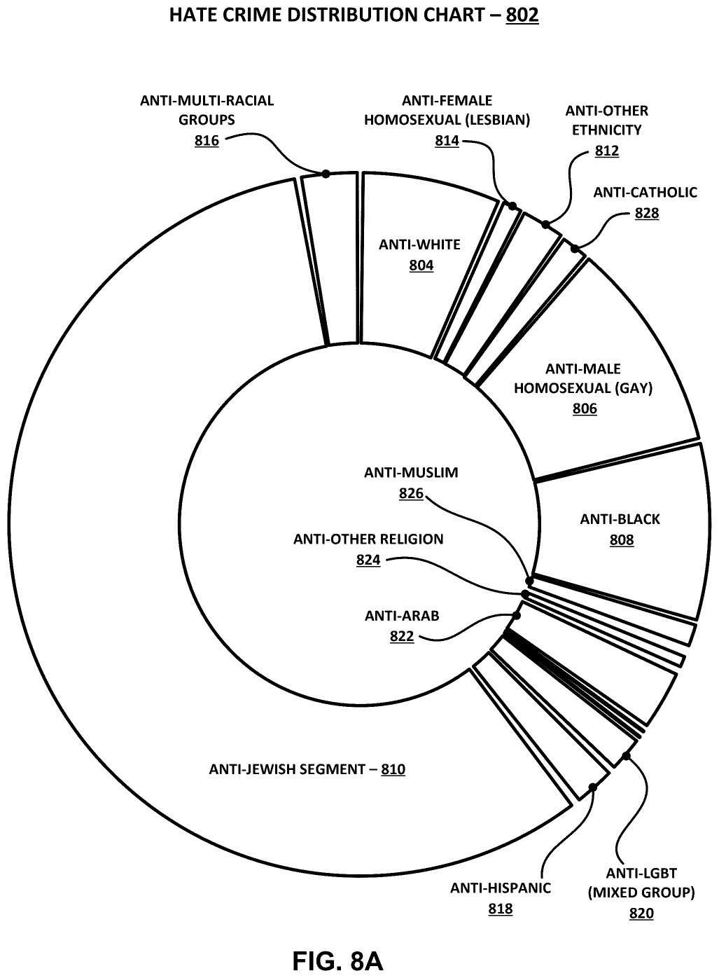

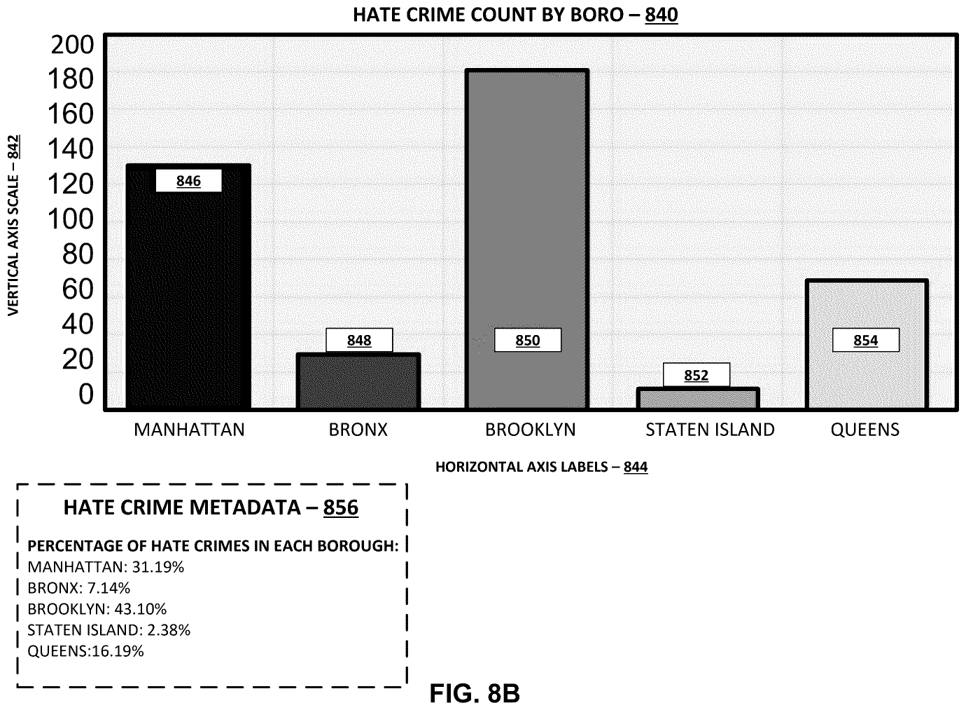

FIGS. 8A and 8B illustrate hate crime dashboard visualizations generated by crimewatch framework 170, in accordance with aspects of the disclosure. FIGS. 8A and 8B illustrate portions of the example dashboard, presented in separate views for clarity.

FIG. 8A illustrates hate crime distribution chart 802, which is shown as a segmented donut chart. Hate crime distribution chart 802 may include categories such as anti-white 804, anti-male homosexual (gay) 806, anti-black 808, anti-jewish segment 810, anti-other ethnicity 812, anti-female homosexual (lesbian) 814, anti-multi-racial groups 816, anti-hispanic 818, anti-lgbt (mixed group) 820, anti-arab 822, anti-other religion 824, anti-muslim 826, and anti-catholic 828. Each segment represents the proportional count of hate crimes directed toward the corresponding group.

FIG. 8B illustrates hate crime count by boro 840, represented as a bar graph. Hate crime count by boro 840 is shown with vertical axis scale 842 and horizontal axis labels 844. The bar graph further includes Manhattan 846, Bronx 848, Brooklyn 850, Staten Island 852, and Queens 854, each representing a borough. Hate crime metadata 856 is also provided, showing calculated percentage values of hate crimes occurring in each borough.

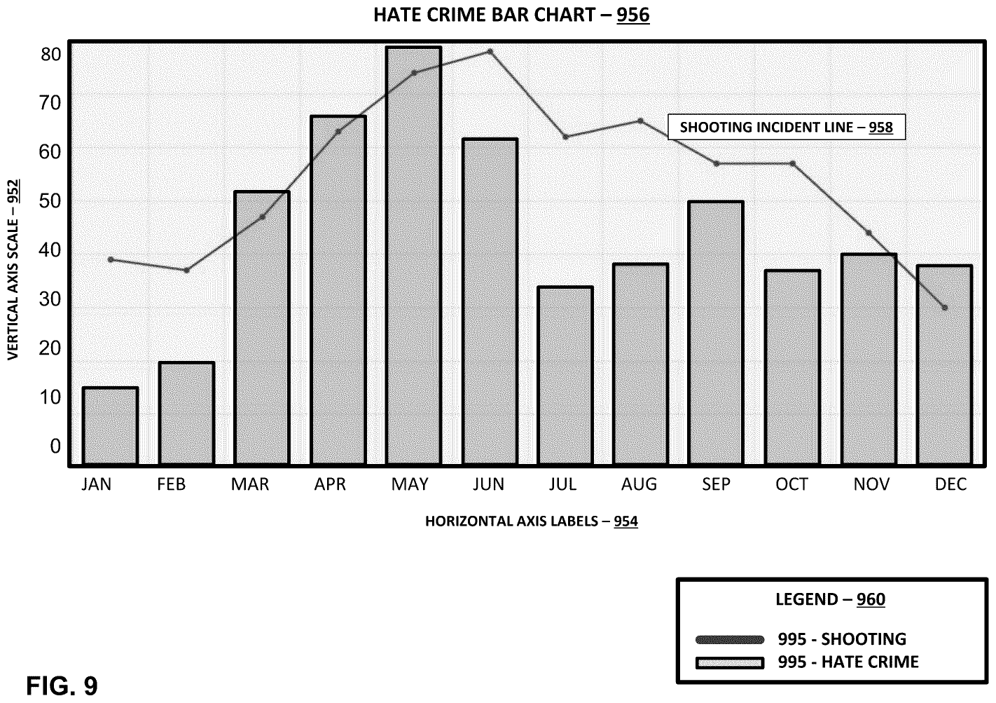

FIG. 9 illustrates a hate crime bar chart 956 in combination with a shooting incident line 958, in accordance with aspects of the disclosure. Hate crime bar chart 956 is aligned with horizontal axis labels 954, which indicate the months January through December, and vertical axis scale 952, which indicates the magnitude of monthly counts. Hate crime bar chart 956 visually represents monthly hate crime counts across the twelve-month period.

Shooting incident line 958 is overlaid on hate crime bar chart 956 and represents shooting incidents distributed across the same twelve-month period, enabling comparison between the two categories.

Legend 960 provides interpretive guidance for hate crime bar chart 956 and shooting incident line 958. In FIG. 9, labels 995 are used to designate the plotted categories “Shooting” and “Hate Crime” within the figure. These textual identifiers clarify the plotted data sources aligned with legend 960. Legend 960 designates plotted values for shooting incident line 958 and bars displayed in hate crime bar chart 956. The combined representation provided in FIG. 9 enables correlation and comparative analysis between hate crime data and shooting incident data across monthly intervals.

Crimewatch framework 170 provides various visualization techniques via dashboard UI module 195 to represent data in the form of two-dimensional trees or graphs showing different concepts and relationships (see FIG. 6A-6C, 7A-7C, 8A-8B, and 9).

An open-source tool such as Protégé may be configured and extended for visualizing developed ontologies. One advantage of using crimewatch framework 170 is its flexible plug-in architecture, which can accommodate the creation of ontology-based applications ranging from straightforward to intricate ones. Extracted information may be used to construct a unified knowledge graph, typically represented as a set of triples with subject, predicate, and object, in accordance with RDF standards.

To query data from multiple RDF graphs, SPARQL may be utilized. SPARQL (SPARQL Protocol and RDF Query Language) is a query language and protocol designed for querying and manipulating RDF (Resource Description Framework) data. It is specifically configured for querying semantic web data and is integral to working with data represented in RDF and related formats.

Implementation and use of crimewatch framework 170 also addresses challenges encountered when working with linked data and seamlessly provides visualizations of incidents occurring in a subject city or geography (such as New York State in the examples depicted herein), together with additional contextual details.

Compared to existing publicly available dashboards or text-based reports, such as those made available by municipal agencies, the framework can provide a more comprehensive and flexible analytical environment. Conventional systems may limit users to fixed metrics or static views, whereas the framework allows interactive filtering by category, demographic attribute, or temporal range. Multiple heterogeneous datasets may be combined within a single application rather than requiring separate tools or reports, thereby streamlining analysis workflows. The architecture also supports incorporation of auxiliary data sources, including alternative public datasets or curated feeds, expanding the scope of analysis. By consolidating these capabilities into one platform, the framework enables stakeholders to gain insights that are broader and more customizable than those obtainable from existing solutions.

Building on the visualization capabilities described above, crimewatch framework 170 also diverges significantly from prior analytical approaches for gaining insights from data sources 196 that provide crime data, such as the NYPD website where data is primarily represented as textual reports with some exceptions like hate crime data which is represented as a dashboard.

Analysis by crimewatch framework 170 may enhance the user experience by providing interactive and visually engaging representation for most of crimewatch framework 170 use cases. For instance, crimewatch framework 170 allows the user to select from an abundance of options, allowing users to personalize their views based on these options. One particular advantage of crimewatch framework 170 is that it provides various metrics related to the different crime types, providing users with a single application for all crime assessment and analysis. Another advantage of crimewatch framework 170 is that the different online resources such as social media data for hate crime data (e.g., data sources 196) may be integrated easily with crimewatch framework 170. This capability provides users with more insights about the crime in New York City or other configured cities and jurisdiction via data sources 196 for such alternative locations.

The framework may further support dynamic updating by enabling queries to be passed directly through to underlying external data sources when appropriate. In these cases, queries initiated at the dashboard level can be translated into real-time requests, retrieving up-to-date records without relying solely on static, preloaded datasets. To maintain responsiveness as data volumes increase, computational resources may be scaled by deploying cloud-based infrastructure or by adding local processing capacity. Query optimization techniques, such as restructuring join operations, caching partial results, or applying indexing strategies, may be employed to reduce latency in SPARQL queries across large RDF graphs. These enhancements enable timely exploration of crime data while accommodating both historical records and continuously refreshed datasets.

Beyond these user-facing advantages, certain implementations of crimewatch framework 170 may also be extended to provide dynamic updating from data sources 196 to avoid over-reliance on historical data. In some examples, where data sources 196 and appropriate APIs exist for accessing such data sources 196, crimewatch framework 170 may enable immediate and up-to-date insights through the use of pass-through queries via query module 190 (see FIG. 1) to enable queries at crimewatch framework 170 to be dynamically translated into updated queries to one or more data sources 196 to check for, and obtain when available, up-to-date data, upon which, crimewatch framework 170 may update rendered dashboards and analysis via dashboard UI module 195.

Geospatial information may also be incorporated into the framework to enhance contextual analysis of crime-related events. Where datasets include latitude and longitude attributes, these values may be associated with external mapping services to provide interactive visualizations of crime distributions. Unsafe-area mapping may be generated by overlaying incident frequencies on borough or precinct boundaries, or by pinpointing exact incident locations on online maps. This integration supports identification of geographic hot spots and offers visual context that can aid law enforcement agencies, policymakers, and community organizations in planning targeted interventions and resource allocation. These mapping capabilities may be further enhanced through the scaling and visualization techniques described in the following section.

As data volumes grow, crimewatch framework 170 may scale computational resources to maintain a low-latency and seamless user experience. For example, queries involving join operations across multiple datasets may be computationally intensive and therefore benefit from on-demand cloud processing or additional localized computing hardware. SPARQL query optimizations may also be applied to efficiently handle large datasets. In some implementations, dashboard UI module 195 may further expose enhanced visual tools, such as correlating crime event data with geographical locations using available longitude and latitude information rendered via online mapping applications. These extended visualizations may assist crime prevention agencies in strengthening surveillance and informing the public about risks in specific regions, thereby supporting more efficient community policing.

Crimewatch framework 170 provides a pivotal tool for addressing the complex challenges associated with crime in urban environments such as New York City. By leveraging Semantic Web technologies, ontologies, and RDF, the framework transforms raw datasets into a structured and interconnected knowledge base. Through comprehensive analysis, visualization, and user-friendly dashboards, crimewatch framework 170 delivers actionable insights into crime patterns, hate crimes, shootings, and complaints. This capability supports informed decision-making, proactive interventions, and the advancement of safer, more inclusive communities.

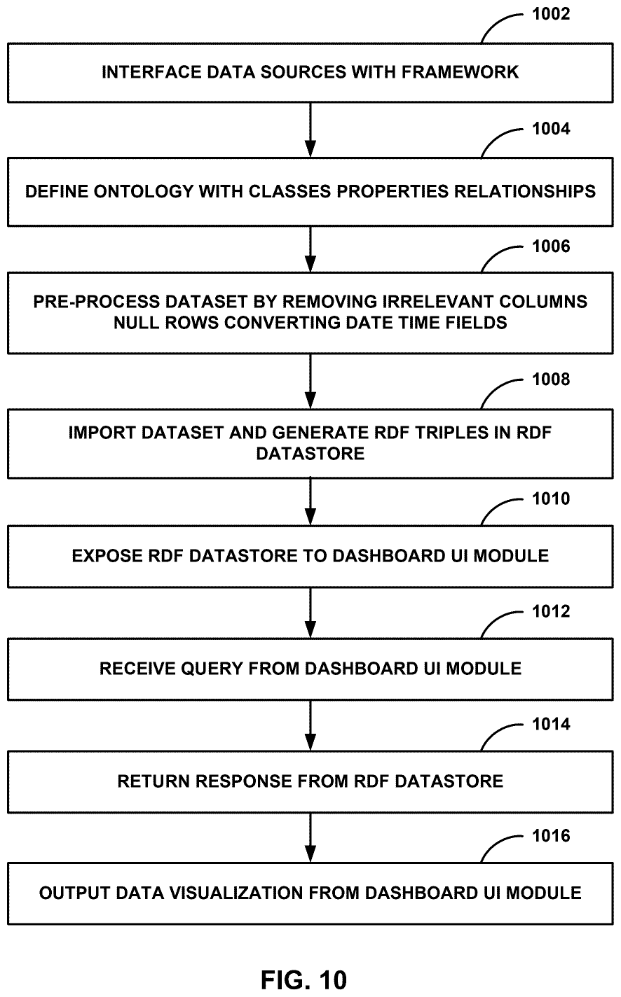

FIG. 10 is a flow diagram illustrating an example method for semantic crime data analysis, in accordance with aspects of this disclosure. FIG. 10 is described with respect to computing device 100 of FIG. 1 and the elements shown therein, including pre-processing module 172, query module 190, dashboard UI module 195, and resource description framework 175. However, the techniques of FIG. 10 may be performed by different components of computing device 100 or by additional or alternative systems.

Processing circuitry of computing device 100 may be configured to interface data sources with framework (1002). For example, computing device 100 may communicably interface with one or more data sources 196 comprising crime-related data and prepare them for use within crimewatch framework 170.

Processing circuitry of computing device 100 may be configured to define ontology with classes, properties, and relationships (1004). For example, ontology design 176 may define classes such as crime, perpetrator, victim, and location, along with object and data properties linking these classes in a structured format. Processed dataset 174 represents the cleaned and normalized dataset output from pre-processing module 172. Data sources 196 provide structured or semi-structured records such as incident reports, complaints, or arrest logs that serve as input.

Processing circuitry of computing device 100 may be configured to pre-process dataset by removing irrelevant columns, null rows, and converting date-time fields (1006). For example, pre-processing module 172 may remove analytically irrelevant columns, drop rows containing null values, and normalize date-time fields into numerical formats suitable for semantic representation.

Processing circuitry of computing device 100 may be configured to import dataset and generate RDF triples in RDF datastore (1008). For example, resource description framework 175 may store the dataset and apply RDF triple generator 178 to create subject-predicate-object relationships consistent with ontology design 176.

Processing circuitry of computing device 100 may be configured to expose RDF datastore to dashboard UI module (1010). For example, resource description framework 175 may provide an interface accessible by dashboard UI module 195, allowing user-facing systems to query the datastore.

Processing circuitry of computing device 100 may be configured to receive a query from dashboard UI module (1012). For example, query module 190 may accept SPARQL queries generated through dashboard UI module 195 based on user interactions.

Processing circuitry of computing device 100 may be configured to return response from RDF datastore (1014). For example, resource description framework 175 may process the received query against stored RDF triples and transmit the result set back via query module 190.

Processing circuitry of computing device 100 may be configured to output data visualization from dashboard UI module (1016). For example, dashboard UI module 195 may transform query results into charts, graphs, timelines, or other visualization formats for display to a user.

In this way, FIG. 10 illustrates a method for structuring, processing, and analyzing crime-related data using a semantic data framework. The method provides a systematic flow from data ingestion through ontology alignment, RDF conversion, semantic querying, and visualization, thereby enhancing analytical capabilities and enabling actionable insights into crime patterns.

This disclosure includes the following examples.
Example 1—A computer-implemented method comprising: interfacing one or more data sources comprising crime-related data with a framework configured for crime data analysis; defining an ontology including classes, properties, and relationships representing the crime-related data; pre-processing the crime-related data to generate a dataset, the pre-processing comprising at least one of removing analytically irrelevant columns, removing rows including fields with null values, and converting date and time fields to numerical values; importing the dataset into a Resource Description Framework (RDF) datastore accessible to the framework; generating RDF triples within the RDF datastore to represent relationships between elements of the dataset; exposing the RDF datastore to a dashboard user interface module; receiving a query from the dashboard user interface module; returning a response to the query from the RDF datastore; and outputting, for display, a data visualization from the dashboard user interface module based on the response.
Example 2—The method of example 1, wherein defining the ontology comprises specifying classes including crime, offender, victim, location, and time, and defining properties linking the classes.
Example 3—The method of example 1, wherein defining the ontology comprises obtaining a definition for the ontology specifying a structured framework that enables both data organization and semantic enrichment of the crime-related data.
Example 4—The method of example 1, wherein pre-processing further comprises removing duplicate fields from the crime-related data.
Example 5—The method of example 1, wherein pre-processing further comprises converting categorical values of the crime-related data into numerical representations.
Example 6—The method of example 1, wherein importing the dataset into the Resource Description Framework datastore comprises transforming the dataset from a tabular format into a linked data format compatible with the ontology.
Example 7—The method of example 6, wherein transforming the dataset comprises applying one or more transformation rules to generate axioms and the RDF triples representing relationships between elements of the dataset.
Example 8—The method of example 1, wherein the Resource Description Framework datastore is hosted on a triple store server configured to respond to semantic queries.
Example 9—The method of example 1, wherein receiving the query comprises receiving a SPARQL (SPARQL Protocol and RDF Query Language) query.
Example 10—The method of example 9, wherein returning the response comprises executing a join operation across multiple RDF datasets.
Example 11—The method of example 1, wherein the data visualization comprises a temporal analysis of crime incidents reported during a selected year.
Example 12—The method of example 1, wherein the data visualization comprises a demographic analysis of shooting incidents based on race, age, or location.
Example 13—The method of example 1, wherein the data visualization comprises a correlation analysis between different categories of crime-related data.
Example 14—The method of example 1, further comprising generating insights from the RDF datastore responsive to the query, wherein the data visualization displays the insights.
Example 15—The method of example 1, wherein returning the response comprises optimizing query execution to provide a near real-time response.
Example 16—The method of example 1, further comprising dynamically updating the Resource Description Framework datastore responsive to changes in the one or more data sources.
Example 17—A system comprising: processing circuitry; non-transitory computer readable media; and instructions that, when executed by the processing circuitry, configure the processing circuitry to: interface one or more data sources comprising crime-related data with a framework configured for crime data analysis; define an ontology including classes, properties, and relationships representing the crime-related data; pre-process the crime-related data to generate a dataset, the pre-processing comprising at least one of removing analytically irrelevant columns, removing rows including fields with null values, and converting date and time fields to numerical values; import the dataset into a Resource Description Framework (RDF) datastore accessible to the framework; generate RDF triples within the RDF datastore to represent relationships between elements of the dataset; expose the RDF datastore to a dashboard user interface module; receive a query from the dashboard user interface module; return a response to the query from the RDF datastore; and output, for display, a data visualization from the dashboard user interface module based on the response.
Example 18—The system of example 17, wherein the instructions further configure the processing circuitry to obtain a definition for the ontology specifying a structured framework that enables both data organization and semantic enrichment of the crime-related data.
Example 19—The system of example 17, wherein the instructions further configure the processing circuitry to receive a SPARQL (SPARQL Protocol and RDF Query Language) query and to return the response from the RDF datastore responsive to the SPARQL query.
Example 20—A non-transitory computer-readable storage medium comprising instructions that, when executed, configure processing circuitry to: interface one or more data sources comprising crime-related data with a framework configured for crime data analysis; define an ontology including classes, properties, and relationships representing the crime-related data; pre-process the crime-related data to generate a dataset, the pre-processing comprising at least one of removing analytically irrelevant columns, removing rows including fields with null values, and converting date and time fields to numerical values; import the dataset into a Resource Description Framework (RDF) datastore accessible to the framework; generate RDF triples within the RDF datastore to represent relationships between elements of the dataset; expose the RDF datastore to a dashboard user interface module; receive a query from the dashboard user interface module; return a response to the query from the RDF datastore; and output, for display, a data visualization from the dashboard user interface module based on the response.
Example 21—A computer program product comprising one or more instructions that, when executed by at least one processor, cause the at least one processor to perform any of the methods of examples 1-16.
Example 22—A device comprising means for performing any of the methods of examples 1-16.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

In accordance with the examples of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

What is claimed is:

1. A computer-implemented method comprising:
interfacing one or more data sources comprising crime-related data with a framework configured for crime data analysis;
defining an ontology including classes, properties, and relationships representing the crime-related data;
pre-processing the crime-related data to generate a dataset, the pre-processing comprising at least one of removing analytically irrelevant columns, removing rows including fields with null values, and converting date and time fields to numerical values;
importing the dataset into a Resource Description Framework (RDF) datastore accessible to the framework;
generating RDF triples within the RDF datastore to represent relationships between elements of the dataset;
exposing the RDF datastore to a dashboard user interface module;
receiving a query from the dashboard user interface module;
returning a response to the query from the RDF datastore; and
outputting, for display, a data visualization from the dashboard user interface module based on the response.

2. The method of claim 1, wherein defining the ontology comprises specifying classes including crime, offender, victim, location, and time, and defining properties linking the classes.

3. The method of claim 1, wherein defining the ontology comprises obtaining a definition for the ontology specifying a structured framework that enables both data organization and semantic enrichment of the crime-related data.

4. The method of claim 1, wherein pre-processing further comprises removing duplicate fields from the crime-related data.

5. The method of claim 1, wherein pre-processing further comprises converting categorical values of the crime-related data into numerical representations.

6. The method of claim 1, wherein importing the dataset into the Resource Description Framework datastore comprises transforming the dataset from a tabular format into a linked data format compatible with the ontology.

7. The method of claim 6, wherein transforming the dataset comprises applying one or more transformation rules to generate axioms and the RDF triples representing relationships between elements of the dataset.

8. The method of claim 1, wherein the Resource Description Framework datastore is hosted on a triple store server configured to respond to semantic queries.

9. The method of claim 1, wherein receiving the query comprises receiving a SPARQL (SPARQL Protocol and RDF Query Language) query.

10. The method of claim 9, wherein returning the response comprises executing a join operation across multiple RDF datasets.

11. The method of claim 1, wherein the data visualization comprises a temporal analysis of crime incidents reported during a selected year.

12. The method of claim 1, wherein the data visualization comprises a demographic analysis of shooting incidents based on race, age, or location.

13. The method of claim 1, wherein the data visualization comprises a correlation analysis between different categories of crime-related data.

14. The method of claim 1, further comprising generating insights from the RDF datastore responsive to the query, wherein the data visualization displays the insights.

15. The method of claim 1, wherein returning the response comprises optimizing query execution to provide a near real-time response.

16. The method of claim 1, further comprising dynamically updating the Resource Description Framework datastore responsive to changes in the one or more data sources.

17. A system comprising:
processing circuitry;
non-transitory computer readable media; and
instructions that, when executed by the processing circuitry, configure the processing circuitry to:
interface one or more data sources comprising crime-related data with a framework configured for crime data analysis;
define an ontology including classes, properties, and relationships representing the crime-related data;
pre-process the crime-related data to generate a dataset, the pre-processing comprising at least one of removing analytically irrelevant columns, removing rows including fields with null values, and converting date and time fields to numerical values;
import the dataset into a Resource Description Framework (RDF) datastore accessible to the framework;
generate RDF triples within the RDF datastore to represent relationships between elements of the dataset;
expose the RDF datastore to a dashboard user interface module;
receive a query from the dashboard user interface module;
return a response to the query from the RDF datastore; and
output, for display, a data visualization from the dashboard user interface module based on the response.

18. The system of claim 17, wherein the instructions further configure the processing circuitry to obtain a definition for the ontology specifying a structured framework that enables both data organization and semantic enrichment of the crime-related data.

19. The system of claim 17, wherein the instructions further configure the processing circuitry to receive a SPARQL (SPARQL Protocol and RDF Query Language) query and to return the response from the RDF datastore responsive to the SPARQL query.

20. A non-transitory computer-readable storage medium comprising instructions that, when executed, configure processing circuitry to:
interface one or more data sources comprising crime-related data with a framework configured for crime data analysis;
define an ontology including classes, properties, and relationships representing the crime-related data;
pre-process the crime-related data to generate a dataset, the pre-processing comprising at least one of removing analytically irrelevant columns, removing rows including fields with null values, and converting date and time fields to numerical values;
import the dataset into a Resource Description Framework (RDF) datastore accessible to the framework;
generate RDF triples within the RDF datastore to represent relationships between elements of the dataset;
expose the RDF datastore to a dashboard user interface module;
receive a query from the dashboard user interface module;
return a response to the query from the RDF datastore; and
output, for display, a data visualization from the dashboard user interface module based on the response.
